(19) United States
(12) Patent Application Publication
(10) Pub. No.: US 2009/0110962 A1
(43) Pub. Date: Apr. 30, 2009

(54) SYSTEM, METHOD AND APPARATUS FOR ELIMINATING ADHESION LAYERS BETWEEN SUBSTRATES AND SOFT UNDERLAYERS IN PERPENDICULAR MEDIA

(75) Inventors: Hong Deng, San Jose, CA (US); Yoshihiro Ikeda, San Jose, CA (US)

Correspondence Address: BRACEWELL & GIULIANI LLP, PO BOX 61389, HOUSTON, TX, 77208-1389, US

(73) Assignee: Hitachi Global Storage Technologies Netherlands BV, Amsterdam (NL)

(21) Appl. No.: 11/930,449

(22) Filed: Oct. 31, 2007

(51) Int. Cl. G11B 5/62; B05D 1/36; G11B 5/82; B32B 7/00

(52) U.S. Cl. 428/846; 360/135; 427/402; 427/419.1; 427/419.7; 428/98

(57) ABSTRACT

A perpendicular media is formed without an adhesion layer between the substrate and soft underlayer (SUL) to reduce the cost of fabrication. The thickness of the SUL is reduced to less than 50 nm to increase the film adhesion strength between the substrate and SUL. The perpendicular media comprises only a substrate, the SUL, an exchange break layer, a recording layer, and a protective overcoat.

### BACKGROUND OF THE INVENTION

1. Technical Field

The present invention relates in general to the construction of perpendicular media and, in particular, to an improved system, method, and apparatus for eliminating an adhesion layer between the glass substrate and the soft underlayer in perpendicular media in order to reduce the cost of fabricating perpendicular media for hard disk drives.

2. Description of the Related Art

Perpendicular recording is becoming the dominant recording technology for the hard disk drive (HDD) industry. With a severe price war taking place between competitors, reductions in the cost of media fabrication is a top priority for all HDD vendors. The perpendicular media tends to have more layers than longitudinal media, and it requires expensive sputtering tools that have more process chambers than conventional sputtering tools.

As shown in FIG. 1, conventional perpendicular media typically comprises six different elements or layers, including: a substrate 11, an adhesion layer 13, a soft underlayer (SUL) 15, an exchange break layer (EBL) 17, a recording layer 19, and a protective overcoat 21. The adhesion layer is primarily used to increase the film adhesive strength to substrates, and may comprise a material such as AlCr, AlTi, CrTi, CrW, NiAl, RuAl, etc. Unfortunately, the entire film structure can be easily peeled off without the adhesion layer.

One way to significantly reduce manufacturing cost is to remove the adhesion layer by using a conventional, low cost sputtering machine with fewer process chambers. Alternatively, one extra chamber may be used in the conventional sputtering machine to improve the media performance without increasing the process chamber numbers. Although these processes are workable, still other solutions for an improved system, method, and apparatus for reducing the cost of fabricating perpendicular media would be desirable.

### SUMMARY OF THE INVENTION

Embodiments of a system, method, and apparatus for eliminating adhesion layers between substrates and soft underlayers (SUL) to reduce the cost of fabricating perpendicular media are disclosed. The thickness of the SUL is reduced from a conventional size of over 100 nm down to a thickness of less than 50 nm. By reducing the total SUL thickness, the film adhesion strength between the substrate and SUL is increased, and the adhesion layer can be eliminated for lower cost production of disk drives having perpendicular media.

In one embodiment, the perpendicular media comprises only a substrate, the SUL, an exchange break layer (EBL), a recording layer, and a protective overcoat. The substrate may be formed from a glass material or an aluminum alloy material. The SUL may comprise one layer or multiple layers formed from non-crystalline, amorphous materials or nanocrystalline materials. The SUL also may comprise multiple layers with non-magnetic or slightly magnetic layers, and the recording layer may be formed from a Co-based alloy with perpendicular anisotropy. The overcoat may comprise a carbon or silicon-based material.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention, which will become apparent, are attained and can be understood in more detail, more particular description of the invention briefly summarized above may be had by reference to the embodiments thereof that are illustrated in the appended drawings which form a part of this specification. It is to be noted, however, that the drawings illustrate only some embodiments of the invention and therefore are not to be considered limiting of its scope as the invention may admit to other equally effective embodiments.

FIG. 1 is a schematic diagram of a conventional configuration for perpendicular media;

FIG. 2 is a schematic diagram of one embodiment of a configuration for perpendicular media constructed in accordance with the invention;

FIG. 3 is a plot of soft under layer thickness versus delamination size for one type of perpendicular media configuration; and

FIG. 4 is a high level flow diagram of one embodiment of a method constructed in accordance with the invention.

### DETAILED DESCRIPTION OF THE INVENTION

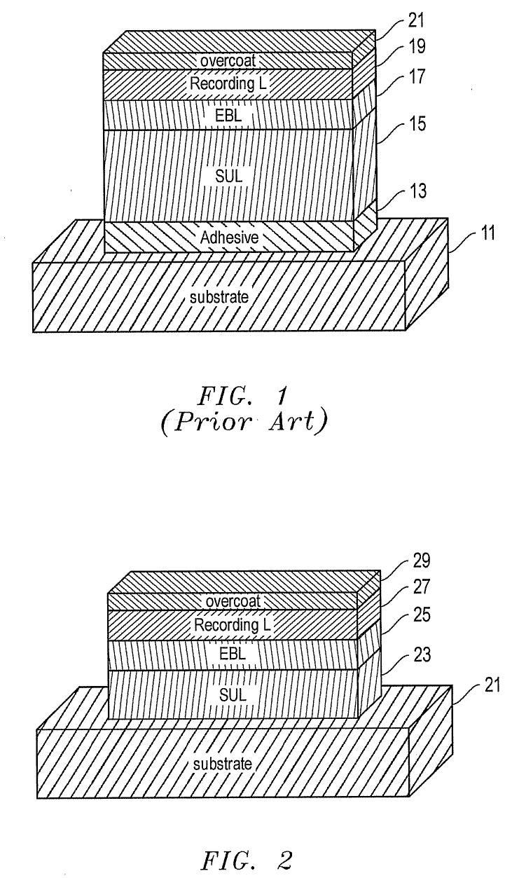

Referring to FIGS. 2-4, embodiments of a system, method and apparatus for eliminating adhesion layers and/or onset layers between substrates and soft underlayers (SUL) are disclosed. Advantageously, the invention significantly reduces the cost of fabricating perpendicular media. The thickness of the SUL is reduced from a conventional size of over 100 nm to a thickness of less than 50 nm. By reducing the total SUL thickness, the film adhesion strength between the substrate and SUL is increased, and the adhesion layer can be eliminated for lower cost production of disk drives having perpendicular media.

In one embodiment (FIG. 2), the perpendicular media comprises only a substrate 21, the SUL 23, an exchange break layer (EBL) 25, a recording layer 27, and a protective overcoat 29. The substrate 21 may be formed from a glass material or an aluminum alloy material. Some aluminum alloy substrates include a protective layer (e.g., NiP) and an oxide layer on the protective layer. The SUL 23 is directly deposited on the substrate 21, which may include the inherent protective and oxide layers.

The SUL 23 may comprise one layer or multiple layers formed from non-crystalline, amorphous materials such as FeCoTaZr, FeCoTaZrB, FeCoTaZrBSi, FeCoTaZrMoB, CoB, CoFeSiB, CoFeB, CoZrTa, CoZrNb, CoZrTaNb, FeCoTaZr, FeCoB, FeCoB, FeCoBCr, FeCoTaB, FeCoTa, and/or FeCoTaCr. Alternatively, the SUL 23 may be formed from microcrystalline or nanocrystalline materials. Microcrystalline and nanocrystalline materials are intermediate structures between amorphous SUL and crystalline SUL. These materials have a short range of order of crystal that is less than 10 nm in size, but in the long range, there is no crystalline correlation between those ordered particles. Its mechanical behavior is very similar to amorphous film rather than crystalline film. In another embodiment, the SUL 23 may comprise anti-ferromagnetically coupled soft magnetic underlayers.

The EBL 25 also may comprise multiple layers with non-magnetic or slightly magnetic layers. The recording layer 27 may be formed from a Co-based alloy with perpendicular anisotropy. The overcoat 29 may comprise a carbon or silicon-based material.

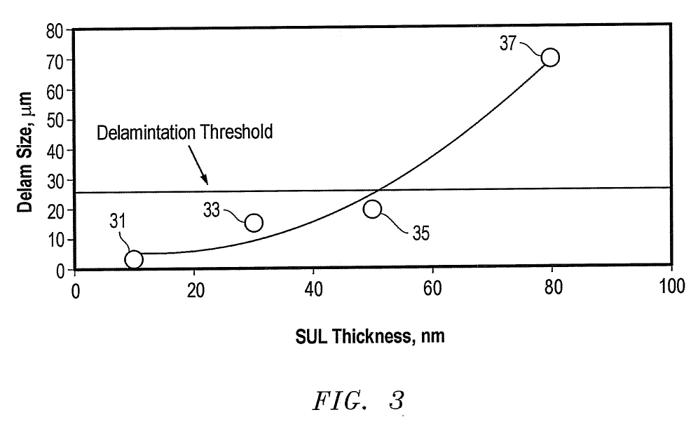

Referring now to FIG. 3, the results of a delamination test for different SUL thicknesses are illustrated. The SULs 31, 33, 35 were formed without an AlTi adhesion layer. As a reference point, the results for a product 37 constructed with an SUL having an 80 nm thickness and an AlTi adhesion layer also is shown. The plot illustrated in FIG. 3 clearly demonstrates that a SUL total thickness of less than 50 nm, has equal or less delamination size (i.e., higher adhesion strength) than the conventional construction 37. Thus, an adhesion layer is unnecessary when the total SUL thickness is less than 50 nm.

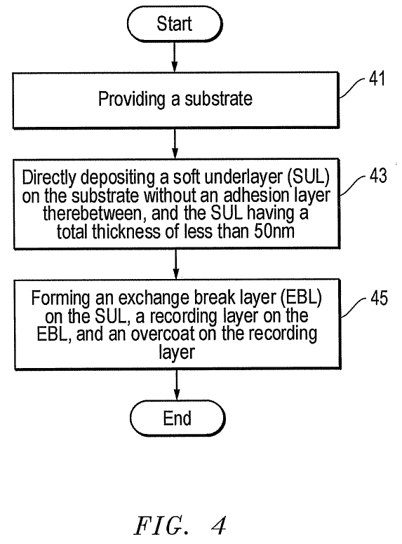

As shown in FIG. 4, one embodiment of a method of the invention comprises forming perpendicular media by providing a substrate (step 41); directly depositing a soft underlayer (SUL) on the substrate without an adhesion layer therebetween, and the SUL having a total thickness of less than 50 nm (step 43); forming an exchange break layer (EBL) on the SUL, a recording layer on the EBL, and an overcoat on the recording layer (step 45); before ending as indicated.

The method also may comprise sputtering the SUL without an atmosphere of krypton or xenon gas, and/or forming the SUL from one or more non-crystalline, amorphous materials. The method also may comprise forming the substrate from a material selected from the group consisting of glass and an aluminum alloy, and/or forming the SUL from one or more layers of material selected from the group consisting of non-magnetic and slightly magnetic materials (e.g., FeCoTaZr, FeCoTaZrB, FeCoTaZrBSi, FeCoTaZrMoB, CoB, CoFeSiB, CoFeB, CoZrTa, CoZrNb, CoZrTaNb, FeCoTaZr, FeCoB, FeCoB, FeCoBCr, FeCoTaB, FeCoTa, and/or FeCoTaCr).

In addition, the method may comprise forming the recording layer from a Co-based alloy with perpendicular anisotropy, and the overcoat from one of a carbon-based and silicon-based material. Furthermore, the method may comprise forming the recording layer without an additional layer of NiCrB or NiCrBCo between the recording layer and the SUL, and forming the recording layer without B₄C.

The invention offers numerous advantages over the prior art. For example, the invention does not require a crystalline SUL for better orientation of the recording layer. The invention also does not require an additional layer of NiCrB or NiCrBCo between the SUL and the recording layer, and it does not require B₄C in the recording layer. In addition, many prior art methods require the SUL to be sputtered with an atmosphere of krypton or xenon gas. Avoiding each of these prior art requirements during the fabrication of perpendicular media further reduces manufacturing costs.

While the invention has been shown or described in only some of its forms, it should be apparent to those skilled in the art that it is not so limited, but is susceptible to various changes without departing from the scope of the invention.

What is claimed is:

1. A perpendicular media, comprising:
a substrate;
a soft underlayer (SUL) on the substrate without an adhesion layer therebetween;
an exchange break layer (EBL) on the SUL;
a recording layer on the EBL; and
an overcoat on the recording layer.

2. A perpendicular media according to claim 1, wherein the SUL is directly deposited on the substrate.

3. A perpendicular media according to claim 1, wherein the SUL has a total thickness of less than 50 nm.

4. A perpendicular media according to claim 1, wherein the substrate is formed from a material selected from the group consisting of glass and an aluminum alloy.

5. A perpendicular media according to claim 1, wherein the SUL comprises one or more layers formed from one or more non-crystalline, amorphous materials selected from the group consisting of FeCoTaZr, FeCoTaZrB, FeCoTaZrBSi, FeCoTaZrMoB, CoB, CoFeSiB, CoFeB, CoZrTa, CoZrNb, CoZrTaNb, FeCoTaZr, FeCoB, FeCoB, FeCoBCr, FeCoTaB, FeCoTa, and FeCoTaCr.

6. A perpendicular media according to claim 1, wherein the SUL comprises one or more layers formed from microcrystalline materials that are smaller than 10 nm.

7. A perpendicular media according to claim 1, wherein the EBL comprises one or more layers of material selected from the group consisting of non-magnetic and slightly magnetic materials.

8. A perpendicular media according to claim 7, wherein the SUL has a total thickness of less than 50 nm.

9. A perpendicular media according to claim 1, wherein the recording layer is formed from a Co-based alloy with perpendicular anisotropy.

10. A perpendicular media according to claim 1, wherein the overcoat is formed from one of a carbon-based and silicon-based material.

11. A perpendicular media according to claim 1, wherein the SUL and recording layer are formed without an additional layer of NiCrB or NiCrBCo therebetween.

12. A perpendicular media according to claim 1, wherein the recording layer is formed without B₄C.

13. A hard disk drive, comprising:
an enclosure;
a disk rotatably mounted to the enclosure, the disk having perpendicular media;
an actuator movably mounted to the enclosure and having a transducer for reading data from the disk; and the perpendicular media further comprising:
a substrate;
a soft underlayer (SUL) directly deposited on the substrate without an adhesion layer therebetween, and the SUL has a total thickness of less than 50 nm;
an exchange break layer (EBL) on the SUL;
a recording layer on the EBL; and
an overcoat on the recording layer.

14. A hard disk drive according to claim 13, wherein the SUL comprises one or more layers formed from one or more non-crystalline, amorphous materials selected from the group consisting of FeCoTaZr, FeCoTaZrB, FeCoTaZrBSi, FeCoTaZrMoB, CoB, CoFeSiB, CoFeB, CoZrTa, CoZrNb, CoZrTaNb, FeCoTaZr, FeCoB, FeCoB, FeCoBCr, FeCoTaB, FeCoTa, and FeCoTaCr.

15. A hard disk drive according to claim 13, wherein the SUL comprises one or more layers formed from microcrystalline materials that are smaller than 10 nm.

16. A hard disk drive according to claim 13, wherein the substrate is formed from a material selected from the group consisting of glass and an aluminum alloy, and the EBL comprises one or more layers of material selected from the group consisting of non-magnetic and slightly magnetic materials.

17. A hard disk drive according to claim 13, wherein the recording layer is formed from a Co-based alloy with perpendicular anisotropy, and the overcoat is formed from one of a carbon-based and silicon-based material.

18. A hard disk drive according to claim 13, wherein the SUL and recording layer are formed without an additional layer of NiCrB or NiCrBCo therebetween, and the recording layer is formed without B₄C.

19. A method of forming perpendicular media, comprising:
(a) providing a substrate;
(b) directly depositing a soft underlayer (SUL) on the substrate without an adhesion layer therebetween, and the SUL having a total thickness of less than 50 nm; and
(c) forming an exchange break layer (EBL) on the SUL, a recording layer on the EBL, and an overcoat on the recording layer.

20. A method according to claim 19, wherein step (b) comprises sputtering the SUL without an atmosphere of krypton or xenon gas.

21. A method according to claim 19, wherein step (b) comprises forming the SUL from one or more non-crystalline, amorphous materials selected from the group consisting of FeCoTaZr, FeCoTaZrB, FeCoTaZrBSi, FeCoTaZrMoB, CoB, CoFeSiB, CoFeB, CoZrTa, CoZrNb, CoZrTaNb, FeCoTaZr, FeCoB, FeCoB, FeCoBCr, FeCoTaB, FeCoTa, and FeCoTaCr.

22. A method according to claim 19, wherein step (b) comprises forming the SUL from one or more layers formed from microcrystalline materials that are smaller than 10 nm.

23. A method according to claim 19, wherein step (a) comprises forming the substrate from a material selected from the group consisting of glass and an aluminum alloy, and step (c) comprises forming the EBL from one or more layers of material selected from the group consisting of non-magnetic and slightly magnetic materials.

24. A method according to claim 19, wherein step (c) comprises forming the recording layer from a Co-based alloy with perpendicular anisotropy, and the overcoat from one of a carbon-based and silicon-based material.

25. A method according to claim 19, wherein step (c) comprises forming the recording layer without an additional layer of NiCrB or NiCrBCo between the recording layer and the SUL, and forming the recording layer without B₄C.
